(19) United States
(12) Patent Application Publication
(10) Pub. No.: US 2010/0320639 A1
(43) Pub. Date: Dec. 23, 2010

(54) Medical Implants with Pre-Settled Cores and Related Methods

(76) Inventors: Christopher Reah, Taunton (GB); Alan McLeod, Taunton (GB)

Correspondence Address: NuVasive;c/o CPA Global, P.O. Box 52050, Minneapolis, MN, 55402, US

(21) Appl. No.: 12/526,489

(22) PCT Filed: Feb. 7, 2008
(86) PCT No.: PCT/US08/53315

§ 371 Date: Aug. 7, 2009

Related U.S. Application Data
(60) Provisional application No. 60/900,277, filed on Feb. 8, 2007.

(51) Int. Cl. B29C 65/00

(52) U.S. Cl. 264/241

(57) ABSTRACT

A treatment process by which medical implants may be pre-settled before surgical implantation. Although explained herein within the context of a spinal implant, it will be appreciated that the same techniques and features of the present invention may be applied to any medical implant, particularly those having a core or other structure subject to material creep over time after implantation. This pre-settling process of the present invention may be done at any stage in the manufacturing of the implantable device after the spinal implant has been formed but before the device is surgically implanted. The pre-settling of the invention may be used for any type of core material that may have creep characteristics including, but not limited to, elastomers and textiles.

### CROSS REFERENCES TO RELATED APPLICATIONS

The present application is an international patent application claiming the benefit of priority from U.S. Provisional Application Ser. No. 60/900,277, filed on Feb. 8, 2007, the entire contents of which are hereby expressly incorporated by reference into this disclosure as if set forth fully herein.

### BACKGROUND OF THE INVENTION

I. Field of the Invention

The present invention relates to medical devices and methods generally aimed at surgical implants. In particular, the disclosed system and associated methods are related to the pre-settling of elastomeric spinal implants to reduce post-surgical material creep.

II. Discussion of the Prior Art

The properties of elastomeric materials make them ideal for use in the construction of medical device components which are both load-bearing and shock absorbing. However, since many biological applications cyclically apply and remove the loads supported by the medical device, permanent deformation of the elastomeric components due to fatigue is a concern. This deformation, or material creep, is especially of concern in applications where the medical device is expected to function and remain stable for a long period of time.

Elastomeric spinal implants are one such application where stability over a long period of time is necessary. One option is to oversize elastomeric spinal implants on implantation in order to compensate for an expected post-implantation loss of height. The natural cycle of application and removal of loads on the elastomeric spinal implant fatigued the implant, deforming the pre-implantation shape through material creep until the inbuilt potential for creep had been achieved, at which time the implant was said to have “settled” and was far more dimensionally stable under the same loads. If the pre-surgical estimates and calculations had been done correctly, the settled) elastomeric spinal implant would end up being the proper size for the intervertebral space in which it had been implanted.

There are several drawbacks to this method of implant sizing. First, oversizing tends to cause an improper implant fit because the loading and unloading forces which will be exerted on the device after implantation may only be estimated, so after the elastomeric spinal implant is settled it may remain larger or have become smaller than the ideal size for a given intervertebral space. Second, difficulties may be had in implanting an object that is too large for the space into which it is being implanted, and the risk of injury to the patient during the surgical implantation is greater with an oversized implant than with a properly sized implant. Finally, oversized implants may damage vertebral bodies or other surrounding biological systems during the post-surgical settling period because of the increased forces on those surrounding systems caused by placement of the oversized implant in a smaller intervertebral space.

The present invention is directed at overcoming, or at least reducing, the post-implantation deformation and material creep caused by material fatigue in order to preclude the practice of oversizing, or at least to reduce the amount of oversize necessary, before implantation of spinal implants.

### SUMMARY OF THE INVENTION

According to the present invention there is a treatment process by which medical) implants may be pre-settled before surgical implantation. Although explained herein within the context of a spinal implant, it will be appreciated that the same techniques and features of the present invention may be applied to any medical implant, particularly those having a core or other structure subject to material creep over time after implantation. This pre-settling process of the present invention may be done at any stage in the manufacturing of the implantable device after the spinal implant has been formed but before the device is surgically implanted. The pre-settling of the invention may be used for any type of core material that may have creep characteristics including, but not limited to, elastomers and textiles.

Spinal implants may be pre-settled by any number of methods which result in fatiguing of the implant, including but not limited to: using a mechanical ram or other load imparting mechanism which would simulate natural spinal loading and unloading, using compression loads within normal ranges or in excess of those expected in vivo, using complex loading patterns, tempering, or chemical treatment. These and other pre-settling methods fatigue the implants and thus cause deformation and material creep before surgical implantation. Since pre-settled implants are much more dimensionally stable and less likely to deform or suffer from material creep after implantation, the fitting of spinal implants into the intervertebral space of a patient may be done much more accurately with pre-settled implants. Further, since a pre-settled implant does not deform or suffer from material creep, or at least does not do so to the magnitude of an unsettled implant, a pre-settled spinal implant may perform more consistently over its service life than an implant which was not settled before implantation.

### BRIEF DESCRIPTION OF THE DRAWINGS

Many advantages of the present invention will be apparent to those skilled in the art with a reading of this specification in conjunction with the attached drawings, wherein like reference numerals are applied to like elements and wherein:

FIG. 1 is a cross sectional view of an elastomeric spinal implant before being subjected to cyclical fatigue according to one embodiment of the present invention;

FIG. 2 is a cross-sectional view of the elastomeric spinal implant of FIG. 1 after the step of pre-implantation settling according to one embodiment of the present invention;

FIGS. 3-4 are perspective and top plan views, respectively, of a generally cylindrically-shaped elastomeric spinal implant according to one embodiment of the present invention;

FIGS. 5-6 are perspective and top plan views, respectively, of a generally cuneal-shaped elastomeric spinal implant according to one embodiment of the present invention;

FIGS. 7-8 are perspective and top plan views, respectively, of a generally polyhedral-shaped elastomeric spinal implant according to one embodiment of the present invention;

FIGS. 9-10 are perspective and top plan views, respectively, of a generally cubic-shaped elastomeric spinal implant according to one embodiment of the present invention;

FIGS. 11-12 are perspective views of an elastomeric spinal implant prior to implantation and in situ, respectively, pre-settled according to the present invention;

FIGS. 13-14 are perspective and side views, respectively, of a spinal implant having an elastomeric core disposed within an embroidered jacket, wherein the elastomeric core is pre-loaded according to the present invention;

FIGS. 15-16 are perspective views (exploded and assembled, respectively) of a spinal implant having an elastomeric core disposed between metal endplates, wherein the elastomeric core is pre-loaded according to the present invention;

FIG. 17 is a cross sectional view of a textile spinal implant before being subjected to cyclical fatigue according to the present invention;

FIG. 18 is a cross-sectional view of the textile spinal implant of FIG. 17 after the step of pre-implantation settling according to the present invention; and

FIG. 19 is a cross-section view of the textile spinal implant of FIG. 18 disposed within an embroidered jacket, wherein the textile core is pre-loaded according to the present invention.

### DESCRIPTION OF PREFERRED EMBODIMENT

An illustrative embodiment of the invention is described below. In the interest of clarity, not all features of actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The process of pre-settling implants disclosed herein boasts a variety of inventive features and components that warrant patent protection, both individually and in combination. Although explained herein within the context of a spinal implant, it will be appreciated that the same techniques and features of the present invention may be applied to any medical implant, particularly those having a core or other structure subject to material creep over time after implantation.

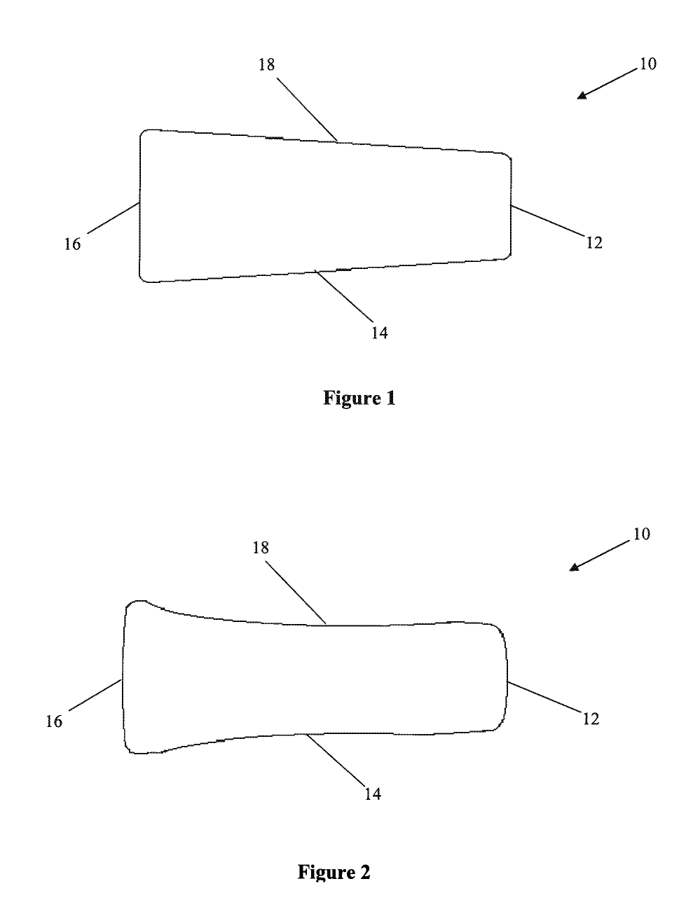

FIG. 1 is representative of a sagittal section of an elastomeric spinal implant 10 prior to being fatigued. The anterior surface 12, the inferior surface 14, the posterior surface 16, and the superior surface 18 are all represented as flat surfaces for the purpose of this illustration. However, actual surfaces of the implant 10 may vary in topography.

FIG. 2 illustrates the elastomeric spinal implant 10 of FIG. 1 after the implant 10 has been fatigued and thus deformed through the process of pre-settling of the present invention. The primary load bearing surfaces, the superior surface 18 and inferior surface 14, are depressed resulting from any number of methods which result in fatiguing of the implant, while the posterior surface 16 and anterior surface 12 are bulging because the material creep radiates orthogonally from the vector direction of the pressure exerted upon the implant 10 which causes its deformation. Deformation of the implant 10 may occur in other geometric configurations, and FIG. 2 is intended only to be illustrative and is not meant to represent curvatures observed medically or scientifically from real elastomeric spinal implants subjected to either natural or pre-implantation settling processes.

After reaching the settled state illustrated in FIG. 2, cyclical application and removal of loads similar in magnitude of force to those which the elastomeric spinal implant 10 absorbed during the settling process may have less, if any, effect on the pre-settled size or shape of the implant 10. Thus, the pre-settled implant 10 of FIG. 2 is dimensionally stable if subjected to forces equivalent to or less than the forces used in the settling process.

Instead of trying to force an oversized, unsettled spinal implant into an intervertebral space predicting that natural fatigue would eventually deform the implant into an acceptable shape and size, and that such natural fatiguing will occur without damaging the vertebral bodies or surrounding biological systems during surgery or in the post-surgical settling period, a properly sized, pre-settled implant similar to the one illustrated in FIG. 2 may be implanted. Implantation of a pre-settled device may be safer and the final sizing may be more accurate, allowing for a more consistent, longer lasting device with a higher probability of successful treatment of the patient receiving the implant.

Elastomeric spinal implants may be designed and manufactured in a variety of shapes. Each shape or combination of shapes allows or restricts certain spinal motions including flexion, extension, lateral bending and torsional rotation. The embodiments described below are examples of possible core shapes and are intended to represent, not limit, the types of shapes possible.

Spinal implant 10 may be constructed from any biocompatible elastic or visco-elastic materials, such as (by way of example only) silicon rubber with a Shore A scale hardness of 35° to 95°. Spinal implant 10 may be dimensioned to be implanted between cervical, thoracic or lumbar vertebrae. Pre-settling is particularly beneficial to implants intended for implantation between lumbar vertebrae, as these vertebrae are subjected to the largest loads in the spinal column and thus subject implants to the largest forces in the spinal column.

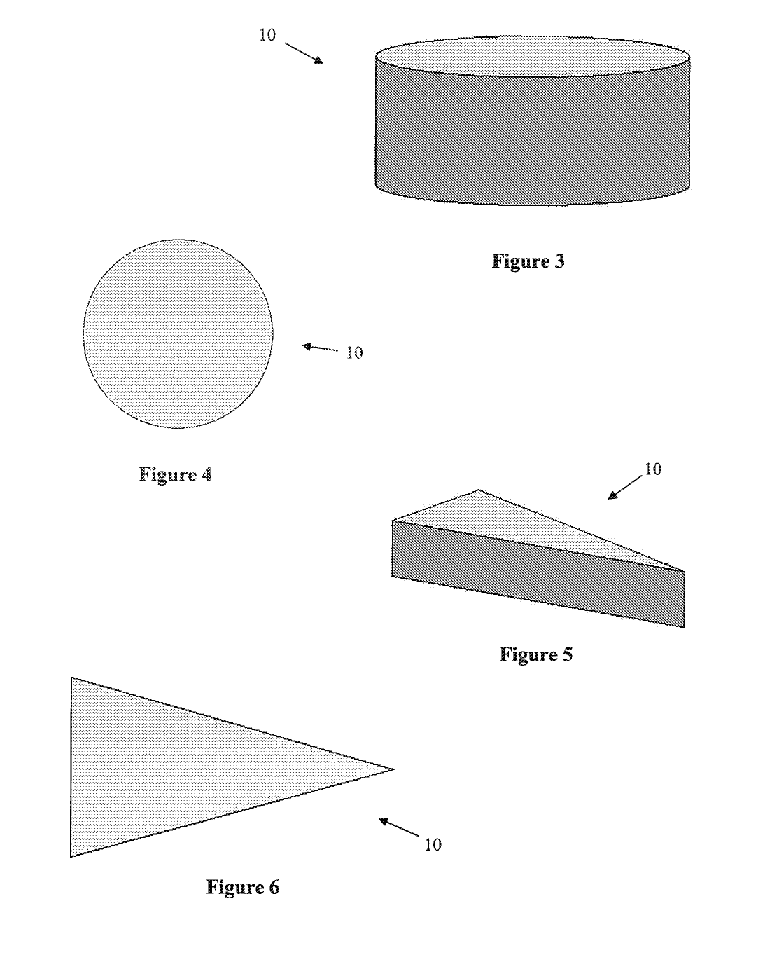

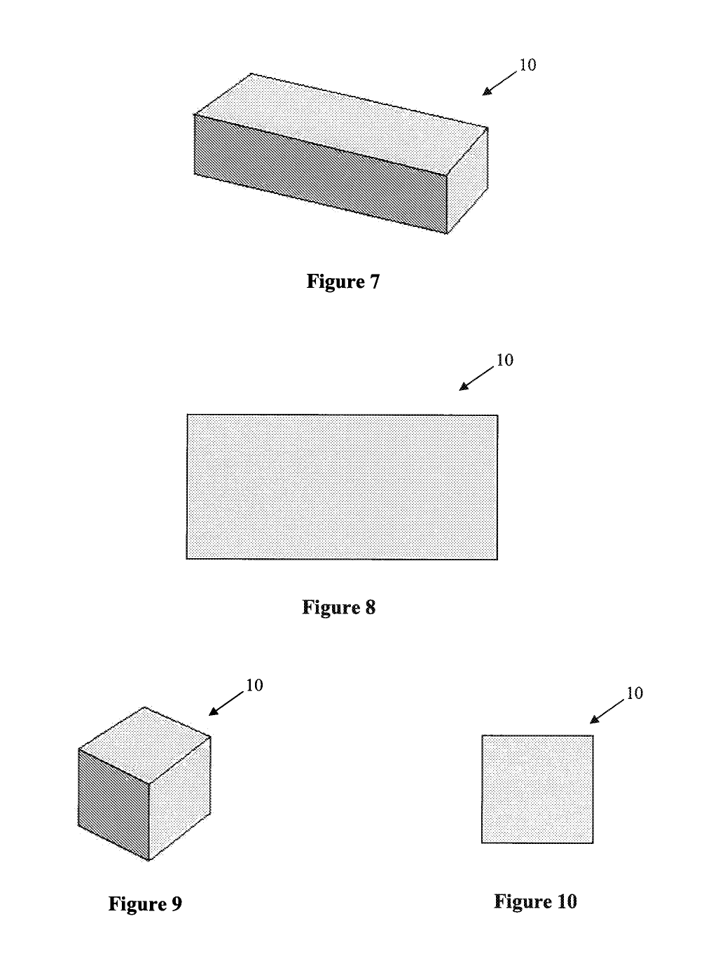

The pre-settling aspect of the present invention may be applied to any spinal implant 10) regardless of shape or size. For example, FIGS. 3-4 illustrate a generally cylindrical elastomeric spinal implant 10. FIGS. 5-6 illustrate a generally cuneal elastomeric spinal implant 10. The shape is generally defined by a solid bounded by two parallel planes and three rectangles orthogonal to the two planes. The rectangles may be arranged such that each rectangle shares two opposing sides; one with each other rectangle. If properly configured, at least one cross-section of the arranged rectangles would be triangular in shape. FIGS. 7-8 illustrate a generally polyhedral elastomeric spinal implant 10. The shape is generally defined as a solid hexahedron bounded by six rectangular polygons. FIGS. 9-10 illustrate a generally cubic elastomeric spinal implant 10. The shape is generally defined as a solid hexahedron bounded by six identical squares.

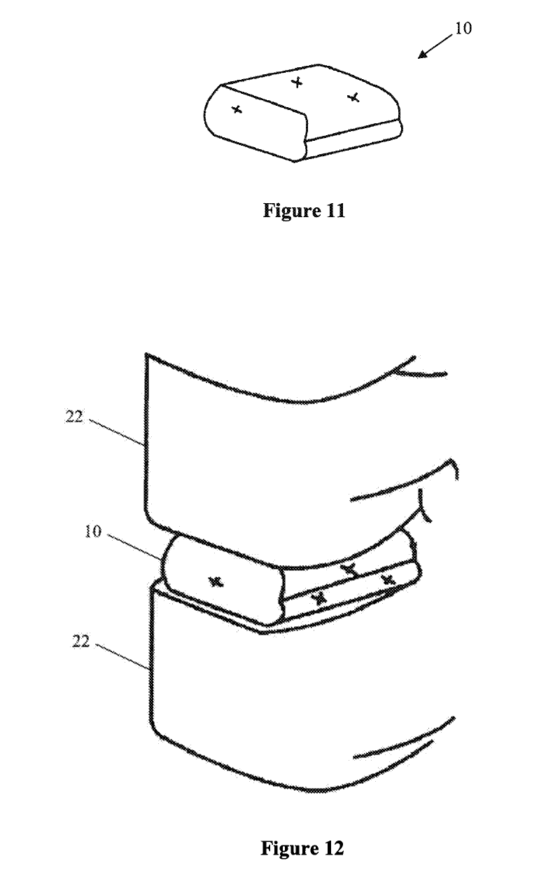

FIG. 11 is an exemplary elastomeric spinal implant 10 the shape of which is a hybridization of more than one of the general implant shapes illustrated above. The implant 10 is generally rectangular, like the implant depicted in FIGS. 7-8, but has rounded edges similar to those of the generally cylindrical elastomeric implant core depicted in FIGS. 3-4. This implant 10 may be surgically implanted by itself or may be incorporated into a larger structure prior to implantation.

FIG. 12 illustrates the direct implantation of the elastomeric spinal implant 10 from FIG. 11 between two adjacent spinal vertebrae 22 after a discectomy has been performed, leaving vacant the disc space between the adjacent spinal vertebrae 22. The implant 10 is inserted into) the disc space, positioned and then secured using mechanical or other means.

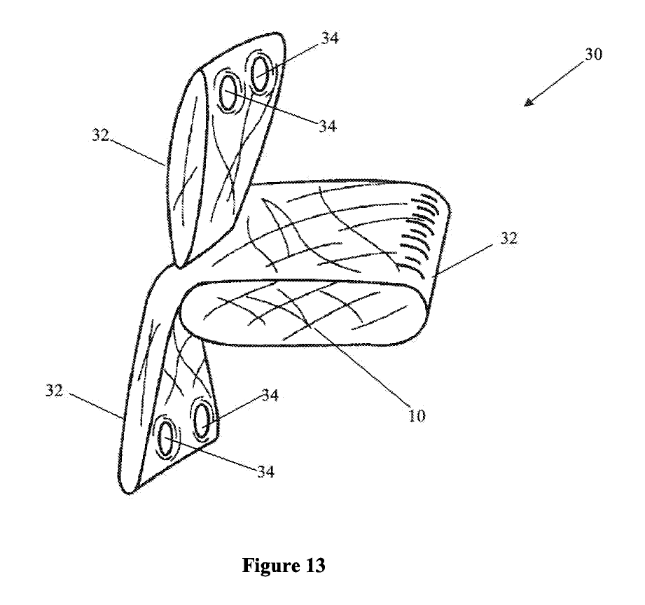

FIG. 13 depicts an exemplary total disc replacement device 30 which incorporates the elastomeric spinal implant 10 from FIG. 11 as the core of a larger structure. The elastomeric spinal implant 10 from FIG. 11 is placed within a fabric sheath 32 which encloses the implant 10. The fabric sheath 32 may be discontinuous, for instance provided with apertures or gaps in the fabric sheath 32. The fabric sheath 32 may engage two or more opposing faces or two or more opposing edges or two or more opposing corners of the implant 10 to restrain it. Engagement with the rear, front, and side faces is preferred. Ideally, engagement with the top and bottom face may also be provided. Full enclosure of the elastomeric spinal implant 10 by the fabric sheath 32 represents a preferred form of the total disc replacement device 30. The fabric sheath 32 may have one or more eyelets 34 located near each corner of the fabric sheath 32 which may be used to allow a spike, screw or other means of fixation to secure the fabric sheath 32 to the adjacent spinal vertebrae.

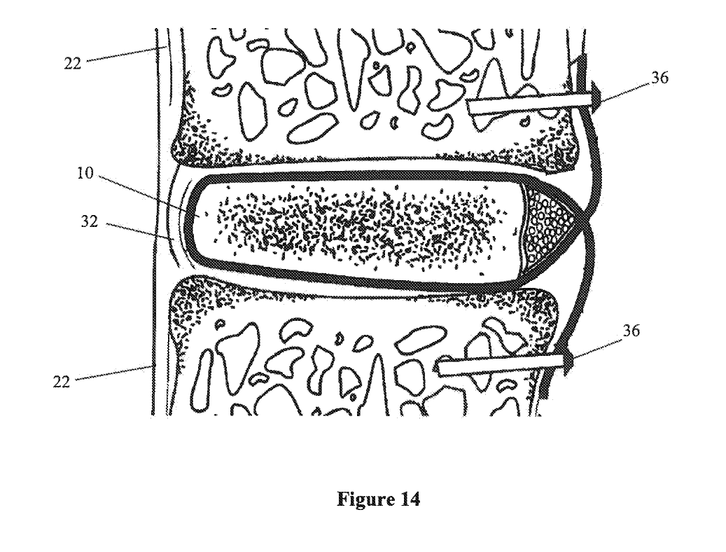

FIG. 14 illustrates the implantation of the total disc replacement device 30 from FIG. 13 into a pair of adjacent spinal vertebrae 22. The portion of the total disc replacement device 30 from FIG. 13 containing the elastomeric spinal implant 10 from FIG. 11 is positioned in the disc space left vacant by a prior discectomy procedure, while the two portions of the total disc replacement device 30 containing the eyelets 34 are held to the spinal vertebrae 22 by mechanical fixation using bone screws 36 turned into the adjacent spinal vertebrae 22.

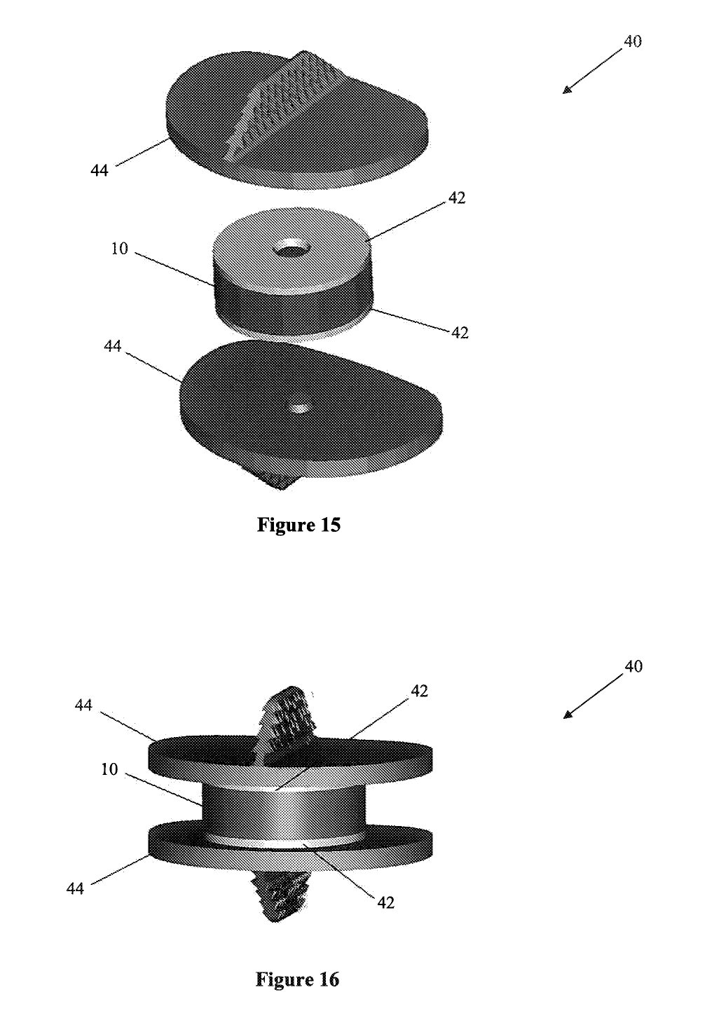

FIG. 15 is an exploded view of an exemplary total disc replacement device 40 with a generally cylindrical elastomeric spinal implant 10 similar in shape of the implant 10 illustrated in FIG. 3-4. This total disc replacement device 40 further demonstrates the principle that elastomeric spinal implants may be incorporated as cores into larger structures prior to implantation. The elastomeric spinal implant 10 is sandwiched between two bearing plates 42 preferably made of metal or ceramic. The implant 10 and bearing plate 42 subassembly is itself sandwiched between two end plates 44, which are also preferably made of metal or ceramic.

FIG. 16 shows the total disc replacement device 40 of FIG. 15 after assembly. When surgically implanted between two adjacent spinal vertebrae, the elastomeric spinal implant 10 allows for flexion, extension and lateral bending motion because the implant 10 is elastic and thus compresses under an applied load. The elastic properties of the implant 10 also provide shock absorption. The total disc replacement device 40 also allows torsional motion because the end plate 44 components are allowed to rotate and translate relative to each other.

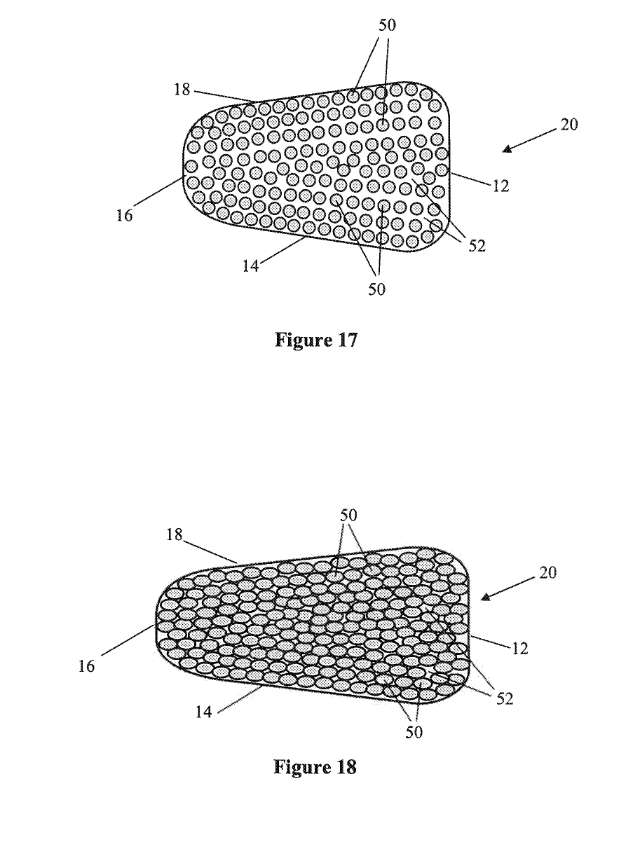

FIG. 17 is representative of a sagittal section of a textile spinal implant 20 prior to being fatigued, according to an alternate embodiment of the present invention. By way of example only, the implant 20 may include a core formed of fibers 50 disposed within an encapsulating jacket. Generally, fibers 50 may comprise any filament having the flexibility for bending to lie along a circuitous path while withstanding encountered in situ loads will be suitable to comprise the filaments described herein. Fibers 50 may be formed of any of a variety of textile materials for example including but not limited to permanent or resorbable polyester fiber, polyethylene (including ultra high molecular weight polyethylene), polyclycolic acid, polylactic acid, metals, aramid fibers, glass strands, alginate fibers, and the like. Moreover, filaments of any number of diameters and shapes including ovoid, square, rhomboid and the like of various circumferences can be appreciated by one skilled in the art as falling within the scope of the present invention. The core and/or jacket may be formed via any number of textile processing techniques (e.g. embroidery, weaving, three-dimensional weaving, knitting, three-dimensional knitting, injection molding, compression molding, cutting woven or knitted fabrics, etc.). The jacket may encapsulate the core fully (i.e. disposed about all surfaces of the core) or partially (i.e. with one or more apertures formed in the jacket allowing direct access to the core). The various fiber 50 layers and/or components of the core may be attached or unattached to the encapsulating jacket. The anterior surface 12, the inferior surface 14, the posterior surface 16, and the superior surface 18 are all represented as flat surfaces for the purpose of this illustration; however, actual surfaces of the implant 20 may vary in topography. In the example shown, the individual textile fibers 50 comprising the core are in a “relaxed” state in that they have a generally circular cross-sectional shape and are reasonably separated by open space 52, which may for example comprise air.

FIG. 18 illustrates the textile spinal implant 20 of FIG. 17 after the implant 20 has been subjected to any of the pre-settling processes described above. The superior surface 18 and inferior surface 14 (the primary load-bearing surfaces) are depressed resulting from any number of methods which result in fatiguing of the implant, while the posterior surface 16 and anterior surface 12 may be bulging because the material creep radiates orthogonally from the vector direction of the pressure exerted upon the implant 20 which causes its deformation. After pre-settling, the individual textile fibers 50 comprising the core of the implant 20 are in a compressed state, having a generally oval cross-sectional shape due in part to the material creep effect radiating orthogonally from the vector direction of the pressure exerted upon each individual fiber 50. The amount of open space 52 is also decreased as the plurality of fibers 50 now occupy less space overall. Due to the relative inelasticity of the materials forming fibers 50, fibers 50 will have a tendency to remain in the compressed state over time. The result is an implant that) has been pre-settled near the compression limits of the fibers 50, which upon implantation will be more able to withstand in situ compressive loads. Deformation of the implant 20 may occur in other geometric configurations, and FIG. 18 is intended only to be illustrative and is not meant to represent curvatures observed medically or scientifically from real textile spinal implants subjected to either natural or pre-implantation settling processes.

It is important to note that the fibers 50 do not experience a change in physical state during the pre-settling process. As used herein, “physical state” is intended to mean the composition of matter with respect to structure, form, constitution, phase, or the like (for example a solid state vs. a liquid or gaseous state). Compression and/or material creep is not considered to be a change in physical state as used herein.

After reaching the settled state illustrated in FIG. 18, cyclical application and removal of loads similar in magnitude of force to those which the textile spinal implant 20 absorbed during the settling process may have less, or no, effect on the pre-settled size or shape of the implant 20. Thus, the pre-settled implant 20 of FIG. 18 is dimensionally stable if subjected to forces equivalent to or less than the forces used in the settling process.

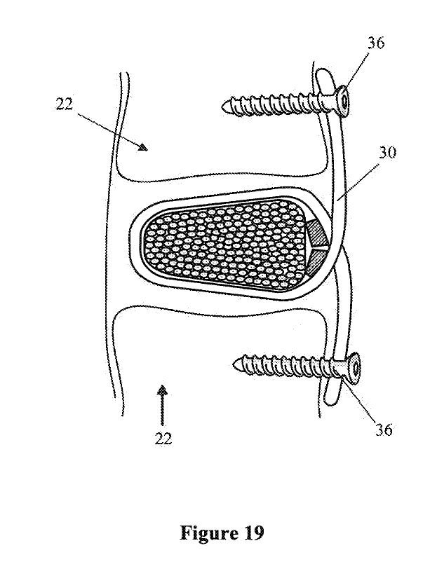

FIG. 19 illustrates the implantation of the total disc replacement device 30 from FIG. 13 into a pair of adjacent spinal vertebrae 22. The portion of the total disc replacement device 30 from FIG. 13 containing the textile spinal implant 20 from FIG. 18 is positioned in the disc space) left vacant by a prior discectomy procedure, while the two portions of the total disc replacement device 30 containing the eyelets 34 are held to the spinal vertebrae 22 by mechanical fixation using bone screws 36 turned into the adjacent spinal vertebrae 22.

The spinal implants described above may be pre-settled by any number of methods which result in fatiguing of the implant, including but not limited to: using a mechanical ram or other load imparting mechanism which would simulate natural spinal loading and unloading, using compression loads within normal ranges or in excess of those expected in vivo, using complex loading patterns, tempering, or chemical treatment. These and other pre-settling methods fatigue the implants and thus cause deformation and material creep before surgical implantation. Since) pre-settled implants are much more dimensionally stable and less likely to deform or suffer from material creep after implantation, the fitting of spinal implants into the intervertebral space of a patient may be done much more accurately with pre-settled implants. Further, since a pre-settled implant does not deform or suffer from material creep, or at least does not do so to the magnitude of an unsettled implant, a pre-settled spinal implant may perform more consistently over its service life than an implant which was not settled before implantation.

Generally, compressive loads are applied in the direction that the implants would tend to lose height under natural compression after implantation. Spinal implants, for example, would be subject to vertical compressive loads, as well as loads simulating flexion and extension. Any number of suitable helpers may be utilized in the compression process, including heat and liquid lubrication, for example.

It will be appreciated that the pre-settling methods and techniques disclosed herein may be performed during any stage of the manufacturing process, for example before and/or after a core element (polymeric or fibrous) is disposed within an encapsulating jacket.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the) contrary, the invention is to cover all modifications, equivalents, and alternatives falling within the spirit and scope of the invention as defined herein.

1. A method of manufacturing a spinal implant, comprising the steps of:
providing a spinal implant having a core element containing fibers disposed within an encapsulating jacket; and
pre-settling said core element such that an amount of air existing within the core between said fibers is minimized.

2. The method of claim 1, wherein said fibers are formed from at least one of polyester fiber, polyethylene, ultra high molecular weight polyethylene, polyclycolic acid, polylactic acid, metals, aramid fibers, glass strands, alginate fibers and any combination thereof.

3. The method of claim 1, wherein at least one of said core element and said encapsulating jacket is formed using embroidery.

4. The method of claim 1, wherein pre-settling said core element comprises using at least one of mechanical simulation of natural spinal loading and unloading, compression loads in excess of natural loads, tempering, and chemical treatment.

5. The method of claim 4, wherein pre-settling said core element further comprises using at least one of heat and liquid lubrication.

6. The method of claim 4, wherein said compressive loads are applied in a vertical direction.

7. The method of claim 4, wherein said compressive loads are applied to simulate at least one of flexion and extension.

8. The method of claim 1, wherein the step of pre-settling said core element occurs after said core element has been disposed within said encapsulating jacket.

9. The method of claim 1, wherein said fibers experience material creep effect during the pre-settling process.

10. A method of manufacturing a spinal implant, comprising:
Manufacturing a spinal implant to include at least a core element; and
pre-settling said core element by subjecting said core element to compressive loads during manufacturing such that an amount of air existing between said fibers is minimized during the step of manufacturing said spinal fusion implant.

11. The method of claim 10, wherein said core element is formed from at least one of an elastomeric material and a plurality of fibers.

12. The method of claim 11, wherein said fibers are formed from at least one of polyester fiber, polyethylene, ultra high molecular weight polyethylene, polyclycolic acid, polylactic acid, metals, aramid fibers, glass strands, alginate fibers and any combination thereof.

13. The method of claim 11, wherein said fibers experience a material creep during the pre-settling process.

14. The method of claim 10, wherein said compressive loads are in excess of natural spinal compressive loads.

15. The method of claim 10, wherein said compressive loads are applied in a vertical direction.

16. The method of claim 10, wherein said compressive loads are applied to simulate at least one of flexion and extension.

17. The method of claim 10, wherein pre-settling said core element further comprises using at least one of heat and liquid lubrication.

18. The method of claim 10, further comprising the step of:
disposing said core element within an encapsulating jacket.

19. The method of claim 18, wherein the step of pre-settling said core element occurs after the step of disposing said core element within an encapsulating jacket.

20. The method of claim 18, wherein said encapsulating jacket is formed from a plurality of fibers.
